(19) United States
(12) Patent Application Publication
(10) Pub. No.: US 2011/0279741 A1
(43) Pub. Date: Nov. 17, 2011

(54) FLEXIBLE AND CONTOURING SCREEN FOR AIRCRAFT PASSENGER CABIN

(75) Inventor: George R. Smallhorn, St-Laurent (CA)

(73) Assignee: INFLIGHT INVESTMENTS INC., St-Laurent (CA)

(21) Appl. No.: 12/781,146

(22) Filed: May 17, 2010

(51) Int. Cl. H04N 5/64

(52) U.S. Cl. 348/837; 348/E05.128

(57) ABSTRACT

A viewing device, including: a base having an upper surface adapted for mounting to a lower contoured surface of an overhead structure in a passenger vehicle; a flexible and contouring viewing screen pivotally mounted to the base for rotary movement of the flexible and contouring viewing screen between a deployed position and a stowed position, wherein the flexible and contouring viewing screen moves from a flat deployed shape in the deployed position to a curved stowed shape that complies to the lower contoured surface of the overhead structure in the stowed position; and a rotary actuator disposed in the base and engaging the screen.

### TECHNICAL FIELD

The invention relates to a flexible and contouring screen to display and to view various visual communications and inflight entertainment services available through equipment installed for viewing by a passenger in an aircraft.

### BACKGROUND OF THE ART

Commercial airlines typically provide inflight entertainment or safety notices in the passenger cabin of large single-aisle aircraft using multiple and small retractable display screens that can be rotated downwards from the overhead left-hand side, (LHS), and right-hand side, (RHS), Passenger Service Unit Rails, (PSU Rails), or the display screens may be mounted in the seat backs facing the passenger. The display screens used to date in this manner are liquid crystal display, (LCD), monitors as are common for television. In larger twin-aisle aircraft, bulkhead mounted reflective screens may be used together with projectors or large LCD or liquid plasma screens can be used in these areas. The retractable display screens of today that are housed within the PSU Rails must be fitted between the Passenger Service Unit, (PSU)Panels which are also housed in the PSU Rails, and are the primary purpose of the PSU Rails, above each and every seat assembly and which contain reading lights, ventilation outlets, flight attendant call buttons and the emergency oxygen masks and both the LCD monitors and the PSU Panels all must be arranged such that the PSU Panels, as required by law, are never outside of the allowable range of each passenger and the LCD monitors must be within the viewing range of each passenger otherwise they defeat their own purpose

Smaller aircraft such as regional aircraft have inadequate space for such retractable display screens within their PSU Rails, which are typically located longitudinally out-board of the bottom of the left and right hand side luggage compartments. Attempting to install a conventional retractable display screen as are typically seen on the larger single-aisle aircraft results in a great deal of extra effort and cost associated with first reworking the arrangement of the PSU Panels themselves to relocate ordinance signs, (No Smoking/Fasten Seat Belts), Public Address Speakers (PA), Reading and Call Lights, Oxygen Masks and Oxygen Generators in order to reduce their footprints and second tore-install the re-worked PSU Panels to create sufficient space for retractable display screens. Even if this re-work is successful, the size of the retractable screen is very limited and there is still the problem of sufficient and suitable space above the re-worked and re-installed PSU Panels to house a retractable display screen when in the stowed position. Further it is also not possible to install retractable screens in-board of the PSU Rails and under the luggage compartments as they will now be considered as an obstruction to the safety of the passengers and will pose a passenger head strike risk and impede egress. For these reasons, installing a conventional display screen in a relatively small regional aircraft cabin will therefore not qualify for airworthiness approval by the US Federal Aviation Administration (FAA) and other national or international aircraft safety regulators. In addition and since the luggage compartments are relatively small, the use of space within the luggage compartments by cutting through their bottoms and allowing the retractable screens to be stowed within the luggage compartment is not acceptable, since space is already very limited and airlines are trying to limit carry-on personal items due to lack of space. Further the concept of installing center-line screens above the aisle can not be accomplished due to the lack of space above the ceiling panels to stow a retractable monitor and the lack of headroom available for accommodating display screens in the ceiling area above the aisle in regional aircraft cabins is very limited and therefore the likelihood that a passenger collides with a deployed or stowed screen is increased leaving nowhere to install the relatively large screens typically used on aircraft in operation today.

Due to the limited space available and the substantial technological obstacles encountered in regional aircraft passenger cabins, the type of visual display equipment common to larger single-aisle aircraft has not been convenient to use in regional aircraft. In addition all designs to date for the larger aircraft introduce power and weight limitations which of course in the smaller and lighter regional aircraft is a great concern. Further, and as in all aircraft, the viewing screens must be easily relocated from their installed locations since the seating configuration is changed from time to time by the operators to suit different operations and flight loads. When seats are relocated, so too must the location of the passenger viewing screens and with minimal effort and time. Despite all of the above limitations it is also an absolute requirement to maintain the minimum quantity of viewing screens at all times since airlines use screens for safety and flight information displays to inform passengers, which drives up the demand for larger sized viewing screens and that demand, in turn, increases the technological barriers.

Features that distinguish the present invention from the background art will be apparent from review of the disclosure, drawings and description of the invention presented below.

### SUMMARY OF THE INVENTION

The invention provides a viewing device, including: a base having an upper surface adapted for mounting to a lower contoured surface of an overhead structure in a passenger vehicle; a flexible and contouring viewing screen pivotally mounted to the base for rotary movement of the flexible and contouring viewing screen between a deployed position and a stowed position, wherein the flexible and contouring viewing screen moves from a flat deployed shape in the deployed position to a curved stowed shape that complies to the lower contoured surface of the overhead structure in the stowed position; and a rotary actuator disposed in the base and engaging the screen.

The flexible and contouring viewing screen consumes no space from the interior of the overhead luggage compartment since it has a thin profile that is mounted below on a lower curved exterior surface. The flexible and contouring screen also reduces the risk, almost to the same level as the luggage compartment itself prior to installation of the flexible and contouring screen, of impact damage to the equipment, physical harm to a passenger, limited visibility and ease of egress due to the ability of the flexible and contouring screen to adhere to the existing contour of the bottom of the luggage when in the stowed position.

The flexible and contouring screen in the curved stowed position complies to the curved lower surface of the overhead luggage structure. This feature reduces the space consumed by the screen and reduces the likelihood of accidental impact or damage.

Further the mounting of a miniature or “Pico” projector, if such an arrangement is selected by the aircraft operator as opposed to the use of a flexible O-LED screen only and base of the flexible and contouring viewing screen with bolts and flush mounted internally threaded inserts to the curved lower surface of the overhead luggage structure, enables rapid installation, relocation and removal. Airlines often reconfigure the seating in aircraft to suit different flights or passenger loads.

Seats are mounted in seat tracks so that the seats can be spaced apart longitudinally at different pitches. Since any downtime is costly, the speed of reconfiguring seats is minimized. If display screens are mounted in seat backs, the display screens are repositioned when the seats are. However typical display screens deployed downwardly from the PSU Rails or by cutting into the luggage storage structure cannot be repositioned as easily.

Accordingly the use of flush mounted internally threaded inserts that can be embedded into the lower surface of the overhead luggage compartment enable rapid removal and relocation. The threaded inserts may be left in place for use when reconfigured back to the original position. Alternatively threaded inserts can be spaced at regular intervals longitudinally along the bottom of the luggage compartments such that the projector and flexible and contouring screen or the flexible O-LED screen can be slidably mounted in overhead tracks.

### DESCRIPTION OF THE DRAWINGS

In order that the invention may be readily understood, an embodiment of the invention is illustrated by way of example in the accompanying drawings.

FIG. 1 is a cross-sectional view through a passenger cabin of commuter type aircraft fuselage showing the backs of a row of four passenger seats separated by a central aisle and two overhead luggage compartments from which two flexible and contouring viewing screens extend downwardly in a deployed position to be viewed by seated passengers.

FIG. 2 is an isometric view looking forward in the passenger cabin showing one flexible and contouring viewing screen in a flat deployed position with an aft mounted projector both in a contoured housing that extends downwardly from the lower contoured surface of the overhead luggage compartment structure.

FIG. 3 is an isometric view looking upward and aftward with the flexible and contouring viewing screen in the deployed position of FIG. 2.

FIG. 4 is a side view in the deployed position of FIG. 2.

FIG. 5 is a side view like FIG. 4 but with the flexible and contouring screen rotated clockwise to the stowed position.

FIG. 6 is an upward looking view with the flexible and contouring screen in the stowed position of FIG. 5

FIG. 7 a detail view of the two arms, electric motor, shafts with universal joint, reduction gears and spring loaded clutch of the rotary actuator in the stowed position.

FIG. 8 is a front view of the rotary actuator of FIG. 7

Further details of the invention and its advantages will be apparent from the detailed description included below.

### DETAILED DESCRIPTION OF PREFERRED EMBODIMENTS

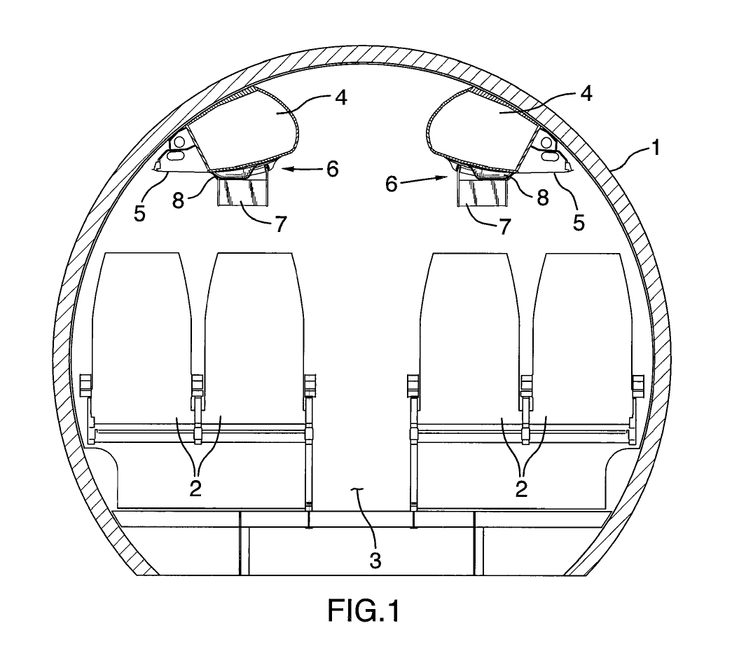

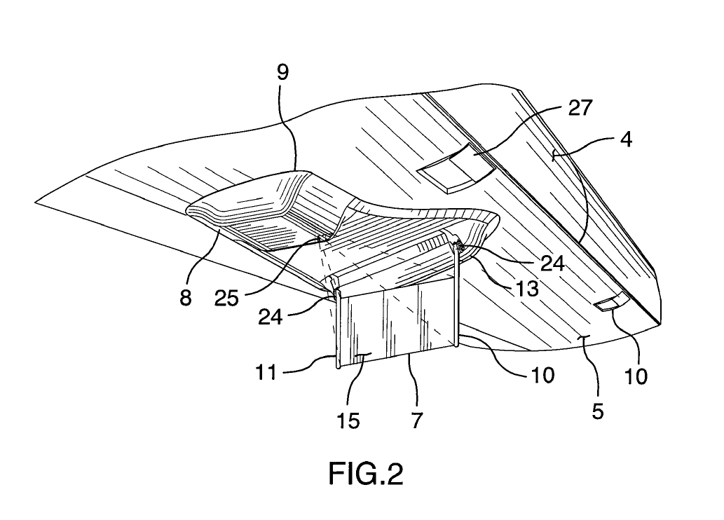

FIG. 1 shows cross-sectional view looking forward through a passenger cabin of commuter type aircraft fuselage 1. Passengers seated in the four passenger seats 2 can stand in the central aisle 3 to store carry on luggage in the compartments provided in the two overhead luggage structures 4. Reading lights, ventilation outlets, flight attendant call buttons, oxygen masks, oxygen generators and other equipment (not shown) are typically provided in a PSU (passenger service unit) mounted in the lower contoured surface 5 of the overhead structures 4. The luggage compartment is accessed through a door released by a handle 27 shown in FIG. 2.

In FIGS. 1-2, the viewing device 6 is shown to include a flexible and contouring projection reflective screen 7, (which may be replaced by a flexible O-LED monitor thus eliminating the “Pico” projector from the total assembly), and a light “Pico” projector 8 that extend downwardly in the deployed position shown to be viewed by the seated passengers. The embodiments of the viewing devices shown in the drawings are a single example of the claimed invention with projector 8.

However use of a flexible OLED (organic light emitting diode) screen eliminates the need for the projector 8 since the flexible OLED screen 7 emits its own light in a manner familiar to those skilled in the art of computer screens, television screens and the like. Therefore it will be understood that the invention includes embodiments that do not include a light projector 8 but do include a flexible screen 7 made of a flexible OLED material.

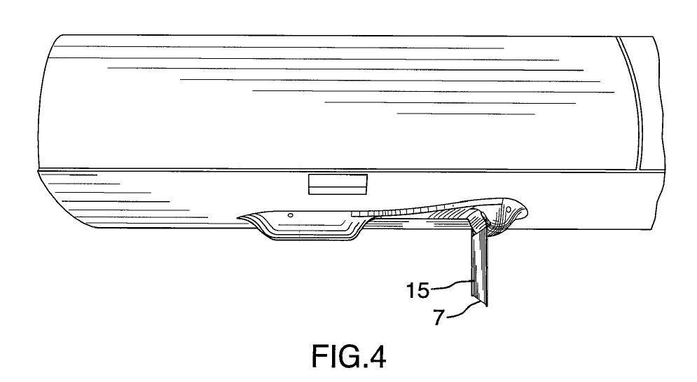

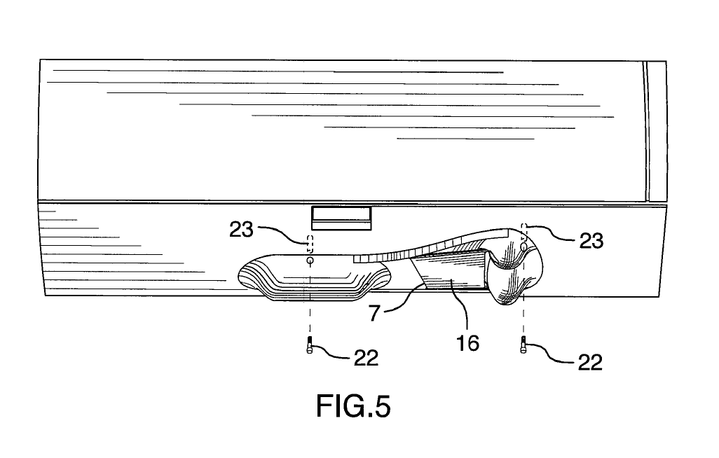

Referring to FIGS. 2-6, the viewing device 6 has a base 9 with an upper surface adapted for mounting to the curvature of the lower contoured surface 5 of the overhead luggage structure 4. The flexible and contouring viewing screen 7 is pivotally mounted to the base 9 with two arms 10, 11 for rotary movement of the flexible and contouring viewing screen 7 between the deployed position (shown in FIGS. 1-4) and the stowed position (shown in FIGS. 5-8).

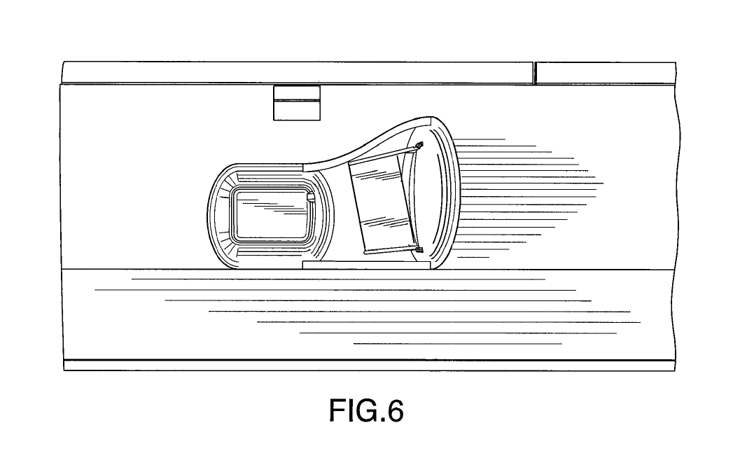

The flexible and contouring viewing screen 7 rotates from a flat deployed shape (FIGS. 1-4) to a curved stowed shape (FIGS. 5-6) that complies to the lowered contoured surface 5 of the overhead structure 4. The base 9 has a relatively thin mid-portion of uniform thickness that complies to the lowered contoured surface 5 of the overhead structure 4.

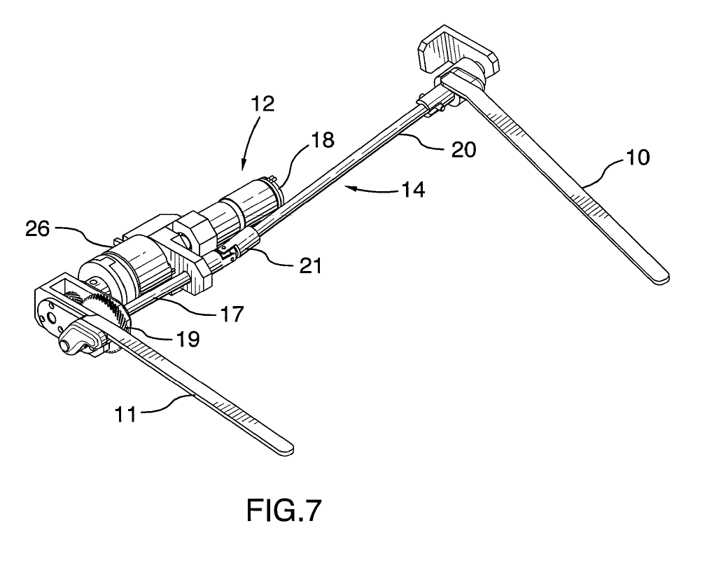

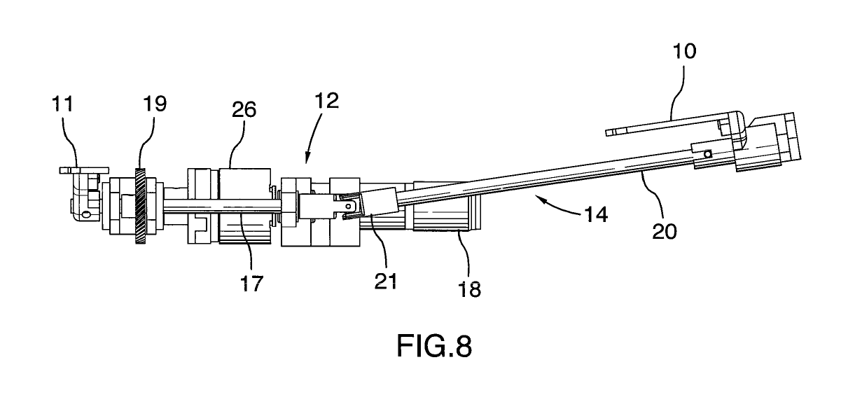

FIGS. 7-8 show the details of the a rotary actuator 12 that is disposed in the actuator housing 13 of the base 9. The rotary actuator 12 engages the screen 7 with inboard arm 10 and outboard arm 11 that mount the screen on the rotary shaft 14. FIGS. 7-8 show the housing 13 removed for clarity but the housing 13 is shown in place in FIGS. 1-6 covering the moving parts of the rotary actuator except for the arms 10, 11 that project through.

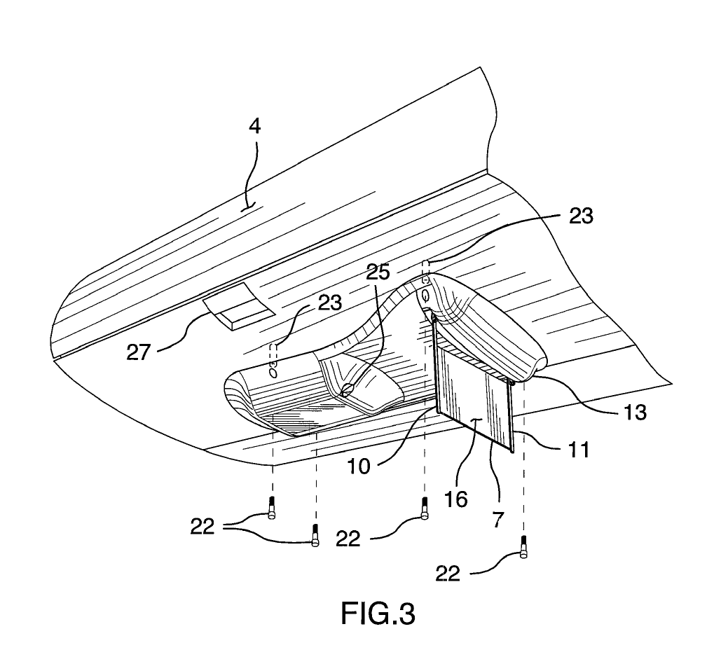

FIG. 2 shows that light from the projector 8 is projected forward to a front viewing surface 15 of the flexible and contouring viewing screen 7. FIG. 3 shows the rear surface 16 of the flexible and contouring screen 7 that can be decorated to match the lower contoured surface 5 of the overhead luggage structure 4. Those skilled in the art will appreciate that some projection screens receive light projected on their rear surface in a reverse arrangement. Therefore it will be understood that the relative positions of the projector 8 and the screen 7 can be reversed. As noted above when an OLED screen is used, the projector 8 may be eliminated also.

As indicated in FIGS. 5-8 a mechanism by which the flexible and contouring screen 7 may be made to conform in shape to the lower contoured surface 5 is for the front viewing surface 15 to engage and be pressed against the mid-portion of the base 9 which is parallel to the lowered contoured surface 5 of the overhead structure 4 in the stowed position. Of course the reverse arrangement may also be used namely where the rear surface 16 engages the mid-portion of the base 9 that is itself conformed to the lower contoured surface 5 (not shown).

FIGS. 7-8 show the mechanical components which include an electric motor 18 that rotates speed reduction gears 19 to drive the first portion 17 of the shaft 14 joined to the second portion 20 of the shaft 14 with a universal joint 21. The spring loaded clutch 26 can spring load the shaft 14 to the stowed position. Of course separate rotary and lateral actuators can be provided using electric motors, pneumatic cylinders or hydraulics and controls can include software to program the extent of rotation and curvature induced by lateral forces.

The universal joint 21 makes the shaft 14 bendable to comply to the lower contoured surface 5 of the overhead structure. Other bendable shafts 14 could be used such as using multiple U-joints 21, an elongate coil spring or flexible rubber cylinder for a shaft 14. The first shaft portion 17 joined to a second shaft portion 20 with a universal joint 21 are separately mounted so that the first portion 17 is oriented to rotate at an angle relative to the second portion 20. This shaft angle partially enables the screen 7 to be curved in the stowed position and flat in the deployed position.

The first shaft portion 17 has the outboard arm 11 fixed to rotate with it and the second shaft portion has the inboard arm 10 fixed thereon. As seen in FIG. 2-4, the flexible and contouring screen 7 is mounted between the arms 10, 11. The arms 10, 11 can also be relatively flexible to ensure shape compliance in the stowed position, to resiliently bias the screen 7 in the stowed position or apply tension to flatten the screen 7 in the deployed position, and to bend if a passenger hits into the arms 10, 11 accidentally.

As seen in FIG. 7 the arms can also be bent having a proximal portion mounted to the shaft 14 disposed at an angle relative to a distal portion to comply to the lower contoured surface of the overhead structure. The arms 10, 11 can be of different lengths so that when rotated on the shaft 14 they each have an arm tip speed. The tip speed of the inboard arm 10 differs from the tip speed of the outboard arm 11 in the embodiment shown due to the different lengths. However if each arm 10, 11 is rotated with a dedicated motor on a separate shaft, the arms 10, 11 can be rotated independently at any selected speed. Accordingly, the stowed shape can be modified using electric motors if desired by rotating the arms independently.

In order to permit easy installation, relocation and removal, the base 9, including projector 8 and actuator housing 13, can be mounted to the lower surface 5 of the overhead luggage structure 4 using removable fasteners such as shown in FIGS. 3 and 5 in the form of removable bolts 22 and flush mounted inserts 23 with internally threaded bores to engage the externally threaded bolts 22. Other means of mounting could include a longitudinally spaced apart series of inserts 23 or a longitudinal PSU rail recessed into the surface 5 (not shown, but known to those skilled in the art).

As seen in FIG. 2, the base 9 includes an external actuator housing 13 with a screen opening 24 through which the arms 10, 11 extend to engage the flexible and contouring viewing screen 7 in the deployed position (FIGS. 1-4) and in the stowed position (FIG. 5-6). The housing for the projector 8 includes an opposing projector opening 25 through which light projects from the projector 8.

The above description relates to a specific preferred embodiment as presently contemplated by the inventor, it will be understood that the invention in its broad aspect includes mechanical and functional equivalents of the elements described herein.

I claim:

1. A viewing device, comprising:
a base having an upper surface adapted for mounting to a lower contoured surface of an overhead structure in a passenger vehicle;
a flexible and contouring viewing screen pivotally mounted to the base for rotary movement of the flexible and contouring viewing screen between a deployed position and a stowed position, wherein the flexible and contouring viewing screen moves from a flat deployed shape in the deployed position to a curved stowed shape that complies to the lower contoured surface of the overhead structure in the stowed position; and
a rotary actuator disposed in the base and engaging the screen.

2. The viewing device of claim 1 wherein the rotary actuator comprises an electric motor engaging a shaft on which flexible and contouring viewing screen is mounted.

3. The viewing device of claim 2 wherein the shaft is bendable to comply to the lower contoured surface of the overhead structure.

4. The viewing device of claim 3 wherein the shaft has a first portion joined to a second portion with a universal joint, wherein the first portion is oriented at an angle relative to the second portion.

5. The viewing device of claim 2 wherein the shaft has an inboard arm and an outboard arm, the flexible screen being mounted to the arms.

6. The viewing device of claim 5 wherein the arms are flexible.

7. The viewing device of claim 5 wherein at least one arm includes a proximal portion disposed at an angle relative to a distal portion to comply to the lower contoured surface of the overhead structure.

8. The viewing device of claim 5 wherein the arms are rotated on the shaft with an arm tip speed, wherein the tip speed of the inboard arm differs from the tip speed of the outboard arm.

9. The viewing device of claim 1 wherein the flexible viewing screen has a front viewing surface; and a rear surface, and wherein at least one of: the front viewing surface; and the rear surface, complies with the lower contoured surface of the overhead structure in the stowed position.

10. The viewing device of claim 1 wherein the device includes a projector and a projector screen.

11. The viewing device of claim 10 wherein the base includes a housing with a screen opening through which the flexible and contouring viewing screen extends in the deployed position, and having an opposing projector opening through which light projects from the projector.

12. The viewing device of claim 1 wherein the device includes a flexible organic light emitting diode (O-LED) display screen.

13. The viewing device of claim 12 wherein the base includes a housing with a screen opening through which the flexible organic light emitting diode (O-LED) display screen extends in the deployed position.

14. The viewing device of claim 1 wherein the base is mountable to the lower contoured surface of the overhead structure with removable fasteners.

15. The viewing device of claim 14 wherein the removable fasteners include a flush mountable insert adapted to be embedded in the lower contoured surface of the overhead structure.

16. The viewing device of claim 15 wherein the insert has an internally threaded bore and the removable fasteners include an externally thread bolt.

17. The viewing device of claim 15 wherein the removable fasteners include a longitudinal mounting rail adapted to be embedded in the lower contoured surface of the overhead structure.
